(19) United States
(12) Patent Application Publication
(10) Pub. No.: US 2026/0290857 A1
(43) Pub. Date: Sep. 24, 2026

(54) CONTROLLED DYNAMIC AIRFLOW CONTROL IN A FUEL CELL SYSTEM

(71) Applicant: INTELLIGENT ENERGY LIMITED, Loughborough (GB)

(72) Inventors: Jesse Dufton, Loughborough (GB); Adam Gordon, Loughborough (GB); Ronan Wilde, Loughborough (GB)

(73) Assignee: INTELLIGENT ENERGY LIMITED, Loughborough (GB)

(21) Appl. No.: 19/563,732

(22) Filed: Mar. 11, 2026

Related U.S. Application Data
(63) Continuation-in-part of application No. 18/280,456, filed on May 20, 2022.
(60) Provisional application No. 63/193,729, filed on May 27, 2021.

(30) Foreign Application Priority Data
May 27, 2021 (GB) 2107547.8

(51) Int. Cl. H01M 8/04014; H01M 8/04223; H01M 8/04701; H01M 8/04746; H01M 8/2475

(52) U.S. Cl. CPC H01M 8/04014; H01M 8/04231; H01M 8/04701; H01M 8/04761; H01M 8/04768; H01M 8/2475; H01M 2250/20

(57) ABSTRACT

Fluid control in a conduit, enclosure or encasement. A fluid pathway in said conduit with a fuel cell stack at one end and a fan at an opposing end. At least one common shaft within conduit with an end extended therethrough connected with outer drive assembly that actuates two sets of coaxial first doors each with one or more of apertures coaxially mounted with two coaxially mounted second doors. The common shaft passes through the doors. Each first door connected to a lower control wheel. Each second door movably connect to a spline on said common shaft at one end to the conduit and the other end passes through the conduit to an upper control wheel. A dual drive wheel is configured to actuate each control wheel. Modes of door movement include actuation that locate each door in either perpendicular or parallel to a fluid flow in said conduit.

### CROSS-REFERENCE TO RELATED APPLICATION

This application is a Continuation In Part of Ser. No. 18/280,456 entitled “Dynamic Airflow Control In A Fuel Cell System” which is a U.S. National Phase Application of International Patent Application No. PCT/GB2022/051287 filed May 20, 2022, which claims priority to Great Britain Patent Application No. 2107547.8 filed May 27, 2021; and U.S. Provisional Patent Application No. 63/193,729 filed May 27, 2021, which are incorporated by reference in their entirety for any and all purposes.

### TECHNICAL FIELD

This disclosure generally relates to devices and methods for controlling and evenly distributing a volume of air through an air-cooled fuel cell stack.

### BACKGROUND

Conventional electrochemical fuel cells convert fuel and oxidant into electrical energy and a reaction product. A common type of electrochemical fuel cell comprises a membrane electrode assembly (MEA), which includes a polymeric ion (proton) transfer membrane between an anode and a cathode flow paths or gas diffusion structures. The fuel, such as hydrogen, and the oxidant, such as oxygen from air, are passed over respective sides of the MEA to generate electrical energy and water as the reaction product. A stack may be formed comprising a number of such fuel cells arranged with separate anode and cathode fluid flow paths. Such a stack is typically in the form of a block comprising numerous individual fuel cell plates held together by end plates at either end of the stack. Such fuel cells can be used to provide power for various technology, such as materials handling equipment (MHE) and stationary power applications and unmanned aerial vehicles (UAVs).

It is important that the polymeric ion transfer membrane used in fuel cells forming fuel cell stack are properly hydrated for efficient operation. It is also important that the temperature of the stack is controlled. Thus, coolant may be supplied to the stack for cooling and/or hydration. It may be necessary at particular times or periodically to purge the flow paths or gas diffusion structures of the fuel cell of coolant, contaminants, or reaction by-products using a purge gas. The purge gas, which may comprise the fuel (e.g. hydrogen) may be flowed through the anode flow path to purge the fuel cell. The process in a simplified description is very quickly turning the fuel cell stack on and off and also referred to as fan pulsing. The faster this pulse occurs the better the fuel cell stack will operate.

In air cooled fuel cell systems, one technique for conditioning fuel cell stacks comprises ‘stack pulsing’ or ‘fan pulsing’, in which air flow to the cathodes of the fuel cell stack is periodically shut off or significantly restricted to starve the cathode of oxygen and the stack is discharged at high current through load resistors, such that energy dissipation occurs during this period of air flow restriction.

Air cooled fuel cell stacks can be very sensitive to cathode air flow. A small amount of air movement through a cathode air flow path can still be enough for the stack to produce significant power. The more unwanted air there is, the harder it is to fan pulse. Therefore, achieving highly restricted air flow during a fan pulse can be desirable. A fan pulse can fail, for example, when blocking air flow is inefficient.

Air cooled fuel cell systems have traditionally restricted the cathode air flow for running in cooler conditions by lowering a fan speed or partially closing a flow pathway. These solutions negatively affect the distribution of the cathode flow through the stack, resulting in temperature variations and consequently, poor stack performance. Partial closure results in turbulent flow when in the partially open position results in the pathway varying. This, in turn, makes the fine control of low volume cathode flow an impossibility. Minimum necessary air volume flow with a fan can result in inefficient cooling and poor stack performance.

### DISCLOSURE

This disclosure of aspects of airflow control are directed to systems, structures, and methods that direct the flow in a desired pattern to control the routing and delivery of airflow in a fuel cell system.

Disclosed herein are aspects of air flow control within a power system utilizing an air-cooled fuel cell stack wherein the traditional problems inherent in dirtier environments which impact performance of a sliding door system are ameliorated.

By eliminating sliding doors as a means to control airflow through adjustable apertures assemblies which have been shown to be susceptible to dirty environments, failure and loss of performance effecting fuel cell stack operation in such environments have been ameliorated.

Sliding doors are eliminated and a combination of coaxial apertured doors and solid doors are utilized. In addition to eliminating the performance loss and failure in dirty environments, the co-axially system reduces over torquing on door control motors.

Disclosed herein are aspects of fluid flow control within an enclosed pathway.

Disclosed herein are aspects of fluid control within an enclosure including but not limited to a system to adjust the airflow to or from a fuel cell stack including a generally tubular encasement forming said fluid pathway, a fuel cell stack in said encasement, a fan at the other end of the encasement. Within the encasement is a common shaft and engaged with the is a drive assembly connected to coaxial doors. In some instances, there are two coaxial first doors each with one or more of apertures and a first door coaxial mount (FDCM) and two coaxial second doors each with a second door coaxial mount (SDCM). Said the common shaft passes through the FDCM and the SDCM and each first door is also connected to a lower control wheel. Each second door is movable connect to a spline on said common shaft and the common shaft is connected at one end to the encasement and the other end to an upper control wheel. A dual drive wheel is configured to independently actuate each of the upper and lower control wheels. Such actuation places each door in either perpendicular or parallel to a fluid flow.

In some instances, the second door is configured to block said one or more apertures when positioned perpendicular to said fluid flow. In some instances, the drive assembly further comprises a control motor in signal communication with a controller, two dual drive wheel each movably attached to a drive gear. Said drive gears are configured to rotate synchronously and each dual drive wheel is configured to rotate said upper control wheel and said lower control wheel into pre-selected positions.

In some instances there is a drive pin slot in each upper control wheel and each lower control wheel and each dual drive wheel is configured with a pin on its first surface and its second surface. Each pin is configured to move in and out of a drive pin slot in the upper control wheel or the lower control wheel.

In some instances each first door or second door rotates when a pin in a drive pin slot is repositioned via the dual drive wheel. In some instances each drive pin engages a drive pin slot through less than 360 degrees of rotation of the dual drive wheel. In some instances each drive pin disengages a drive pin slot through less than 360 degrees of rotation of the dual drive wheel and when a drive pin is disengaged from a drive pin slot the dual drive wheel moves freely thus reducing overstressing of the drive assembly.

Disclosed herein are aspects of fluid control within an enclosure including but not limited to a method to adjust fluid flow in an enclosure including an enclosure configured with a fluid pathway. Mounting a first and a second coaxial rotating doors to a common shaft in said enclosure within the fluid pathway, wherein one of the coaxial rotating doors is configured with a plurality of apertures therethrough and one of the coaxial doors is solid. One end the common shaft is connected to an upper control wheel whereby when said control wheel rotates it moves one of the first or second coaxial rotating doors. The other coaxial rotating door is movable affixed the lower control wheel which the common shaft passes through but does not rotate. A rotating a dual drive wheel is configured to independently actuate both the upper and lower control wheels whereby said doors are moved into positions which place one or more of them either perpendicular to a fluid flow or parallel to the fluid flow.

In some instances the second door is configured to block the fluid flow through said plurality of apertures when positioned perpendicular to the fluid flow. In some instances the drive assembly includes a control motor in signal communication with a controller and drive gears are configured to move synchronously. Whereby said synchronous gears are each attached to and rotate a dual drive wheel and, each dual drive wheel is configured to rotate an upper control wheel and a lower control wheel into pre-selected positions. In some instances a drive pin slot in each upper control wheel and each lower control wheel and each dual drive wheel is configured with a pin on its first surface and its second surface. Each pin is configured to move in and out of a drive pin slot in the upper control wheel or the lower control wheel.

In some instances each first door or second door rotates when a pin in a drive pin slot is repositioned via the dual drive wheel. In some instances each drive pin engages a drive pin slot during predetermined degrees of rotation which are less than 360 degrees of rotation of the dual drive wheel. In some instances each drive pin disengages a drive pin slot during predetermined degrees of rotation less than 360 degrees of rotation of the dual drive wheel and when a drive pin is disengaged from a drive pin slot the dual drive wheel moves freely thus reducing overstressing of the drive assembly.

It is appreciated by those skilled in the art that some of the circuits, components, controllers, modules, and/or devices of the system disclosed in the present application are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying analog and/or digital formats without passing through a direct electromagnetic connection. These information paths may also include analog-to-digital conversions (“ADC”), digital-to-analog (“DAC”) conversions, data transformations such as, for example, fast Fourier transforms (“FFTs”), time-to-frequency conversations, frequency-to-time conversions, database mapping, signal processing steps, coding, modulations, demodulations, etc. The controller devices and smart devices disclosed herein operate with memory and processors whereby code is executed during processes to transform data, the computing devices run on a processor (such as, for example, controller or other processor that is not shown) which may include a central processing unit (“CPU”), digital signal processor (“DSP”), additional memory may be added, application specific integrated circuit (“ASIC”), field programmable gate array (“FPGA”), microprocessor, etc. Alternatively, portions DCA devices may also be or include hardware devices such as logic circuitry, a CPU, a DSP, ASIC, FPGA, etc. and may include hardware and software capable of receiving and sending information.

### DRAWINGS

The present application is further understood when read in conjunction with the appended drawings. For the purpose of illustrating the subject matter, there are shown in the drawings exemplary aspects of the subject matter; however, the presently disclosed subject matter is not limited to the specific methods, devices, and systems disclosed. In the drawings:

FIG. 1 is an external view of a prior system and method for controlling airflow to a fuel cells stack and a fan.

FIG. 2A is a component view which illustrates aspects of the previous implementations of system and method for controlling airflow through a fuel cells stack.

FIGS. 2B and 2C illustrate aspects of a fluid control assembly of FIG. 2A.

FIGS. 3-4B illustrate aspects of exemplary implementations showing the adjustable airflow of the system and method disclosed herein.

FIG. 5 is a table of some operation modes of the prior system and method disclosed herein for controlling airflow to a fuel cells stack and a fan.

FIGS. 6A-7B illustrate aspects of exemplary implementations showing the adjustable airflow of the prior system and method.

FIG. 8 is an assembly view showing aspects of dual rotating coaxial doors for controlling fluid flow and drive assembly components.

FIGS. 9A-9D illustrates the door components of the dual rotating doors shown in FIG. 8.

FIGS. 9E-9H illustrates assembly of the door components of the dual rotating doors shown in FIG. 8 configured to attach to a drive system;

FIG. 10A shows a partially transparent view of the dual rotating coaxial doors forming a flow control means mounted in a housing.

FIG. 10B shows the external housing of FIG. 10A.

FIG. 11A show dual rotating coaxial doors in sealed or obstructed position.

FIG. 11B show dual rotating coaxial doors in restricted or partially obstructed position.

FIG. 11C show dual rotating coaxial doors in open or unobstructed position.

FIG. 12 is a side view of the dual drive wheel connected to a drive system.

FIG. 13 is a top partial view of the upper control wheel and the dual drive wheel engaged.

FIGS. 14A-14I are top views aspects of the dual drive wheel and the upper control wheel sequentially moving an indicator illustrating aspects of the controlled movement of a wall or door visa vie the system and method disclosed herein.

FIGS. 15A and 15B illustrate aspects of sensor and sensor positional activator interaction and use for determining door position.

FIGS. 16A-16D shows aspects of partially obstructed dual rotating coaxial doors shown in FIG. 11B removed from the enclosure with aspects of the drive system.

FIG. 16E illustrates the sensor positional activators of the upper and lower control wheel relative to location sensors of FIG. 16C.

FIGS. 17A-17D shows aspects of partially obstructed dual rotating coaxial doors in transition from partially obstructed to sealed.

FIG. 17E illustrates the sensor positional activators of the upper and lower control wheel relative to location sensors of FIG. 17C.

FIGS. 18A-18D shows aspects of the dual rotating coaxial doors in the sealed or obstructed position.

FIG. 18E illustrates the sensor positional activators of the upper and lower control wheel relative to location sensors of FIG. 18C.

FIGS. 19A-19D shows aspects of the transition from sealed dual rotating coaxial doors to unrestricted.

FIG. 19E illustrates the sensor positional activators of the upper and lower control wheel relative to location sensors of FIG. 19C.

FIGS. 20A-20D the shows aspects of unobstructed dual rotating coaxial doors.

FIG. 20E illustrates the sensor positional activators of the upper and lower control wheel relative to location sensors of FIG. 20C.

Aspects of the disclosure will now be described in detail with reference to the drawings, wherein like reference numbers refer to like elements throughout, unless specified otherwise.

### FURTHER DISCLOSURE

Fine control of low volume coolant flow through a fuel cell stack in a small footprint for air cooled fuel cell system has previously eluded a practical solution. Disclosed herein are aspects of methods, devices and systems which utilize air routing, coarse and fine control of airflow to provide consistent fuel cell stack operation in a variety of conditions including but not limited to start-up, hot operation and cold or cool operation.

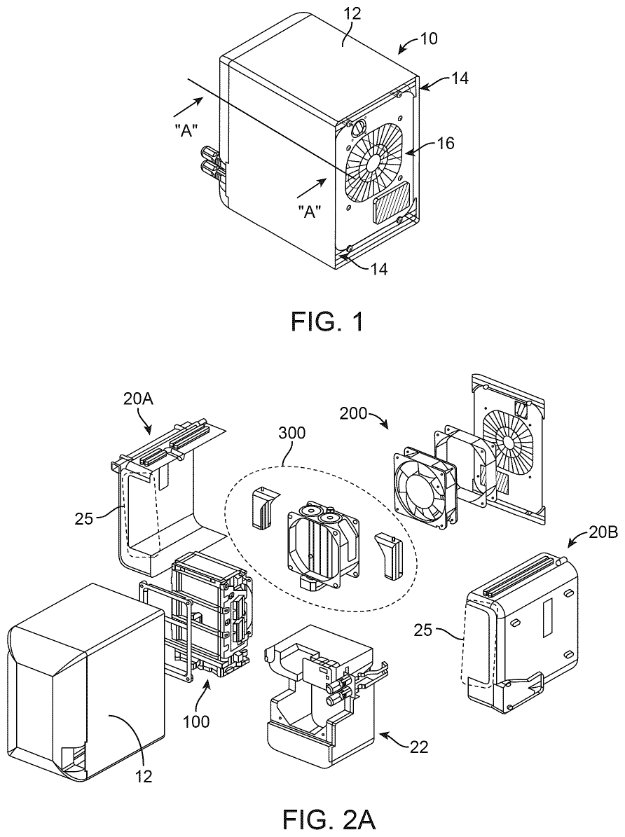

FIGS. 1 through 7B illustrate a control mechanism solution using louvre doors with sliding portions to open and close apertures.

In a most basic configuration, the systems and methods disclosed herein control fluid flow through a fuel cell stack is controlled via a series of louvres, aperture, and bypass valves. The innovative system provides for coarse and fine adjustment of the fluid flow.

Fans drawing airflow through a fuel cell stack cool the stack dilute expelled hydrogen, enable efficient operation of the stack through a multitude of power requirements, and support parodic purging of the system to preserve membrane efficiency and thus health of the fuel cell stack.

One or more louvre doors are configured to each rotate from a fully closed position through a range of positions to a fully open position and each louvre door is multipart having at least two sliding plates whereby each door in a closed position is configured for one plate to slide vertically upward or downward relative to the other and perpendicular to the cathode exhaust flow whereby the sliding movement opens, partially closes or fully closes a series of aligned apertures in the plates effectively throttling up or down air flow through the closed plates. Although apertures are shown as elongated in the horizontal direction, that illustration is not limiting, and other aperture shapes are within the scope of this disclosure. The elongated shape does support large flow volume with less movement of sliding aperture plates and as such in some instance is preferred as it supports at least smaller systems and/or higher flow.

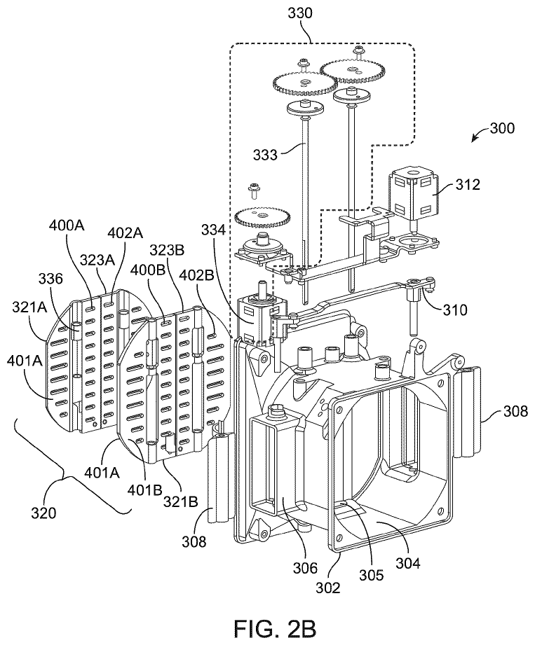

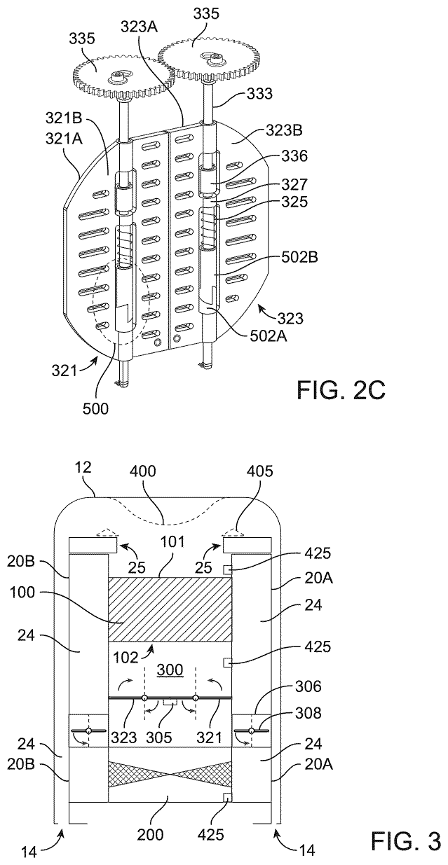

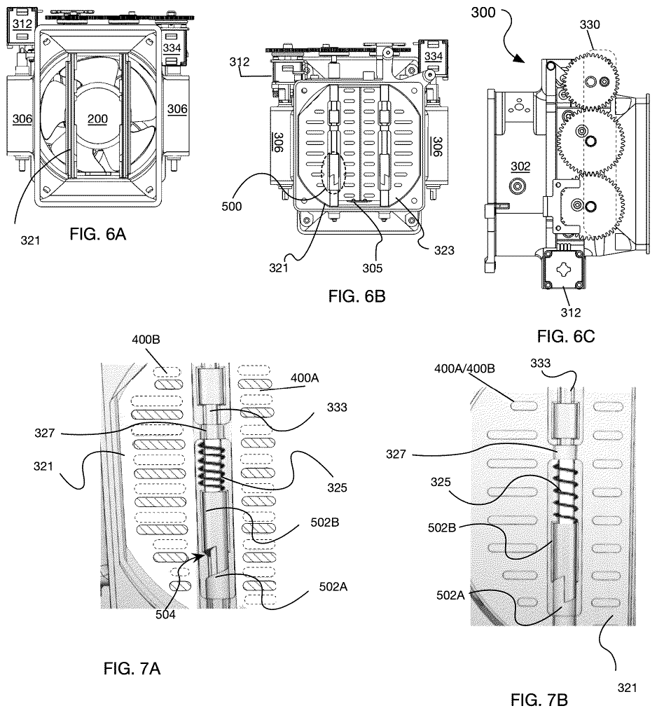

FIGS. 1-2C show aspects of an air distribution device and system 10. A main housing 12 configured with entryways 14 for air flow into the housing and an exit 16 for fluid flow out of the housing. Within the housing a subassembly shown here as having two sides 20A and a positional insert 22. The subassembly could be formed of less or more pieces and those of ordinary skill in the art or the skilled artisan will recognize such a design choice will remain within the scope of the disclosure. The subassembly surrounds the fuel cell stack 100 at one end a fan 200 at the opposite end and downstream from the fuel cells stack but upstream from the fan is a fluid control assembly 300 which fluidly connects the entryways 14 air pathways through fluid channel 24 to the intake face 25 for the stack whereby air flow travels from the entryways to the fuel cell stack. The subassembly contains a fuel cell stack 100 at one end and a fan 200 and downstream from the fuel cells stack but upstream from the fan is the fluid flow assembly 300. The fluid control assembly is a base which both fluidly connect the cathode exhaust to the fan and controls airflow into and exhaust out of the fuel cell stack. A flow control housing 302 provides a fan duct 304 which supports a magnetic catch 305 to hold louvre doors in a closed position and at least one bypass duct 306. Each bypass duct houses a valve 308 which can be open or closed via a control arm 310 attached to a bypass motor 312 and controlled by a controller. Aperture louvre doors 320 are affixed movable to the flow control housing. Each door is formed of two plates. A first door consists of nested plates 321A and 321B. Each plate has a first surface 401A and a second surface 401B. Each plate has elongate apertures 400A and 400B formed therethrough which can be aligned. A second door consists of nested plates 323A and 323B and the plates each have elongate apertures 402A and 402B formed therethrough which can be aligned. The nested plates should fit tightly to minimize fluid leakage and at least one of the nested doors should be sufficiently lubricious to slide upward and downward vertically against the other door. A louvre control assembly 330 is affixed to each set of nested door via a drive shaft 333 which fits into a guide formed through the pair of nested doors. A drive motor 334 is part of the louvre control assembly. The drive shafts 333 are driven by a geared connection shown in the louvre control assembly. The geared assembly is not a limitation there are a plethora of means to rotate a shaft or a pair of shaft via gears and motors known in the art. The pass-through guides 336 are not part of the rotation or door movement, the drive shafts are connected to the louvre doors via cams which act to rotate the door open or closed. The magnet 305 stops the doors in the fully closed position (FIG. 6B). The magnet is a means to stop the louvre movement, other means such as ball plunger, and other latches and catches are within the scope of this disclosure. It is preferred that rotation of the drive shafts after closure will adjust the apertures from open to partially open to closed. FIGS. 2C, 7A and 7B shows the nested plates (321A/321B and 323A/323B) forming louvre doors 321 and 323. Each door is movable connected to the drive shaft 333 via a cam 500. The cam has a lower drive section 502A which is affixed to the drive shaft and an upper drive section 502B is affixed to the nested plate which will be driven upward and downward relative to the flow control housing 302. A spring means 325 through which the drive shaft extends is placed between the cam 500 and the louvre guide 327. When the sliding plate is moved upward by the cam action it compresses the spring and when the cam action lowers the sliding plate the spring decompresses and moves the sliding plate downward to align the apertures. FIG. 7A shows the elongated aperture 400A through the first nested plate of louvre door 321 misaligned with the elongated aperture 400B in the second nested plate of louvre door 321 as such the elongated apertures, in this configuration, block fluid flow through that louvre door. The lower drive section 502A of the cam upon rotation of the drive shaft 333 is moved downward to close the gap 504 between the upper and lower drive sections as shown in FIG. 7B and the elongated aperture 400A and 400B are aligned to allow fluid flow, the spring means urges the sliding plate downward during the cam rotation. Moreover, the louvre doors are controlled by the moving means (shown here as a stepper motor 334) the moving means causes the gears 335 to rotate the shafts in a coordinated fashion. In some instances, a motor controller is in signal communication with the moving means. In other instances, the motor control is incorporated within the system controller. If a motor control is present, it is in signal communicating with a system controller whereby the louver door and elongated aperture positions are adjusted. The system controller is configured to adjust the bypass valves, louvre doors and apertures is to respond to measurements within the system or conditions of the system. Measurements via sensors 425 include but are not limited to one more of power requirements, temperature, pressure, humidity, hydrogen concentration in the exhaust, stop, fan pulsing, and purging. Sensors are in signal communication with the system controller and may be placed anywhere in the system and the indication of sensors 425 near the intake face 101 of the fuel cell stack near the fluid control assembly and near the fan are not limitations.

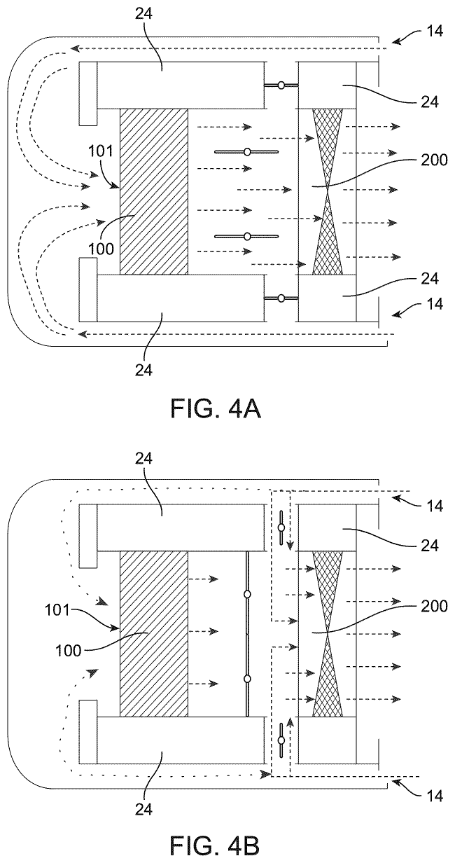

FIGS. 3 to 4B illustrate a cut away top view looking downward generally along the line of FIG. 1 at A-A. Only block structures showing main component are provided these figures illustrate airflow during different states of the system. Not all states are shown. Some states go from fully closed with 0% aperture opening through the spectrum to 100% open including all partial opening within that spectrum. For the sake of brevity only fully open louvres, fully closed louvres with fully closed apertures and fully closed louvers with apertures fully open are shown and the absence of in-between state of partially open and closed apertures should not be interpreted as a mere intermediary or non-disclosed invention.

Disclosed herein are methods of operating the fuel cell power system wherein the minimum volume of airflow for the fan 200 to operate is maintained via control of airflow via louvres, bypass valves and apertures. The fan during operation, even at low RPM, moves a minimum volume of air through the system, via the airflow dynamic control disclosed herein when the airflow requirements through the fuel cell stack are less than the minimum airflow requirements of the fan the system controller engages at least one of the bypass valves and the louvres to direct airflow while maintaining the necessary minimum airflow. If less than the minimum airflow is available the fan, the fan is put under increased load thereby reducing efficiency of the system and increasing parasitic loss. The airflow steering by the fluid flow assembly 300 is controlled by the controller.

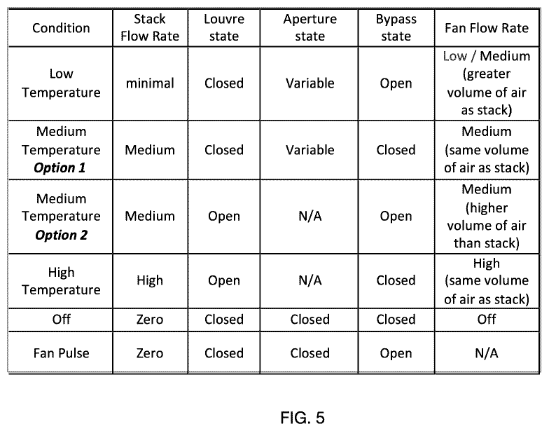

Fluid flow which includes atmospheric air enters the system via entryways 4 into the fluid channel 24 which is also in fluid connection with the fuel cell stack. The fluid flow assembly 300 also provides for the louvres to go from fully open to fully closed position in a short time period. The rapidity of the opening and closing of the doors in conjunction with the bypass valves and ducts cooperate to provide at least the necessary minimum volume of air to fan and to provide the required volume of airflow to the fuel cell stack first face 101 under a variety of conditions and is this dynamic and responsive to the system sensors 425. Directing airflow from the fluid channel 24 while bypassing the fuel cell stack and doors. FIG. 5 is a table illustrating state of operation, operational modes and the coordination of the louvre doors closing and opening with the apertures therein opening and closing and the opening and closing of the bypass valves configured to be operated by at least one controller.

During high temperature operation (see FIG. 4A and the table in FIG. 5) the bypass valves 308 are closed and airflow through the fluid channel is not disrupted. Rather, the airflow passes through the fluid channel to the intake face and the louvre doors 321 and 323 are opened to distribute the airflow from the fluid channel to one of the first face 101 and the fan 200. The apertures are in an open state because the open louvre doors have a moving means for the sliding of the doors (321A/321B and 323A/323B) and the at rest state is open.

During high temperature mode operation (FIG. 4A) the largest volume of fluid is passed through the fluid channel to the first face 101 via closing the bypass valves 308 forcing at least 90% of the intake air to be drawn through the stack via the intake face. In this mode it is preferred that 95% of the fluid is drawn through the stack and it is most preferred that 99% or more air is drawn through the stack in this mode. In this first mode the louvers are fully open producing minimal hindrance to the cathode exhaust fluid being expelled from the system via the fan's 200 axial flow. Ideally the same volume of air flowing into the entryways 14 passes through the fuel cell stack. Additional benefits of this operation are to ensure that very low concentration of hydrogen is present within the cathode flow.

During operation of the system, it is also beneficial to cause turbidity to the fluid flow which enters the fuel cell stack. The fuel cell stack 100 has a first face 101 and a second face 102. The first face 101 is configured to be in fluid connection with fluid channel 24 and receive air via the intake face 25. To increase dispersion of the fluid flowing within the housing 12 at one end of the housing opposite the first face 101 optionally a convex bump 400 (FIG. 3) may be formed to provide a Coanda effect, the phenomenon in which a jet flow attaches itself to a nearby surface and remains attached even when the surface curves away from the initial jet direction, guiding the air towards the center of the first face. In some instances, air disrupting fingers 405 may also be placed around the intake face to disrupt the fluid flow and cause more even distribution across the first face 101. These flow disruption features when situated on the intake face transform the linear flow of intake fluid into a turbulent flow just prior to being ingested by the fuel cell stack. This helps to distribute the fluid evenly rather than only being drawn into the periphery of the stack. The disrupting fingers and the Coanda effect may be used cooperatively or separately.

During a low temperature mode configuration (see FIG. 4B) the louvre doors 321/323 are closed and the bypass valves 308 are opened to allow a higher volume of air to flow to the fan through the bypass valves then to the fuel cell stack. This configuration and method of operation provide for the majority of fluid in the fluid channel to be expelled rapidly from the system without interacting with the fuel cell stack. In this second mode the elongated apertures 400A and 400B in the closed louvres are used to throttle fluid exiting the stack as cathode exhaust and only allow the necessary volume of intake fluid (such as air) to flow through the fuel cell stack. A controller in signal communications with the means moving the louvre doors which may be the louvre control assembly 330 and the bypass motor 312 and bypass vents 308 are configured to coordinate opening and closing of each to support fuel cell stack and fan operation. The controller is further configured to vary the upward or downward movement of the sliding nested doors forming the louvres to change the volume of fluid which passes through the apertures.

During a first medium temperature mode configuration (see FIG. 5) the louvre doors 321/323 are closed and the bypass valves 308 are closed to direct the same volume of air to flow to the fan and through the fuel cell stack. In this third mode of operation the elongated apertures 400A and 400B in the closed louvres are used to throttle fluid exiting the stack as cathode exhaust and only allow the necessary volume of intake fluid (such as air) to flow through the fuel cell stack. The controller in signal communications with the means moving the louvre doors is configured to vary the upward or downward movement of the sliding nested doors forming the louvres to change the volume of fluid which passes through the apertures.

During a second medium temperature mode configuration (see FIG. 5) the louvre doors 321/323 are open and the bypass valves 308 are open thus providing a larger volume of air flow to the fan than the fuel cell stack.

FIGS. 6A-6C show basic operation louvre doors. In high temperature mode when maximum airflow through the fuel cell stack is required the louvre doors 321/323 are open (FIG. 6A) and the by-pass valves are closed. In a restricted fluid flow configuration, which is one of low temperature or medium temperature the louvre doors 321/323 are closed (FIG. 6B) the magnet 305 holds them in the closed position and cams 500 are in the lowered position whereby the elongated apertures 402A/402B are aligned in the open position and configured so that maximum fluid volume which can flow through the aligned apertures. FIG. 6C shows a top view of the flow control housing 302 and the cooperative gears forming the means to both open and close the louvres and to slide upward and downward one of the nested plates 321A/321B and 323A and 323B. FIGS. 7A and 7B show a partial view of the apertures closed off (FIG. 7A) and a partial view of the apertures aligned and open (FIG. 7B) via the cam movement.

In some instances sliding door systems of aperture controlled fluid within a fuel cell stack air may fail or perform poorly in dirtier environments and spring loaded cams are particularly susceptible to such dirt and during thousands of hours of operation the failure rates increased as the mechanism for door sliding and the moving of louvre doors from one position to another are compromised by at least one of the environment and the wear and tear on cam springs. The FOD (foreign object debris) and dust moving thorough the system also will reduce airflow by blocking filter materials causing fans to work harder and creating increased noise of operation,

We have discovered that in some instances nested or sliding doors with apertures and internal cams face debris and dirt challenges. If the cam system or the doors become impacted with dirt, foreign object debris (FOD) and excessive dust the operation of the cam mechanism described above and/or the sliding aperture systems may be degraded, damaged or fail.

We have developed an alternative system for controlling fluid flow via moving doors which does not suffer operational problems or failure from FOD, dirt and dust.

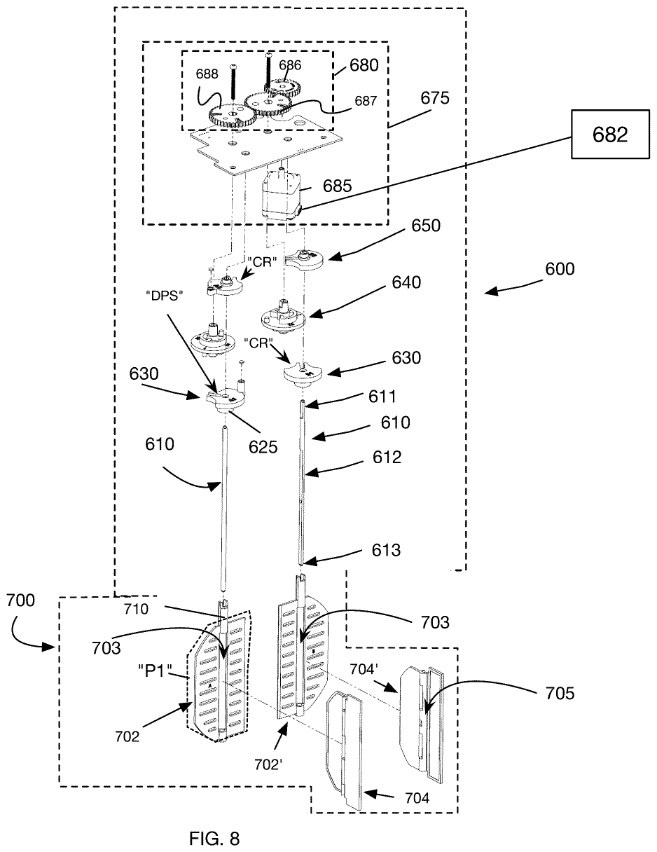

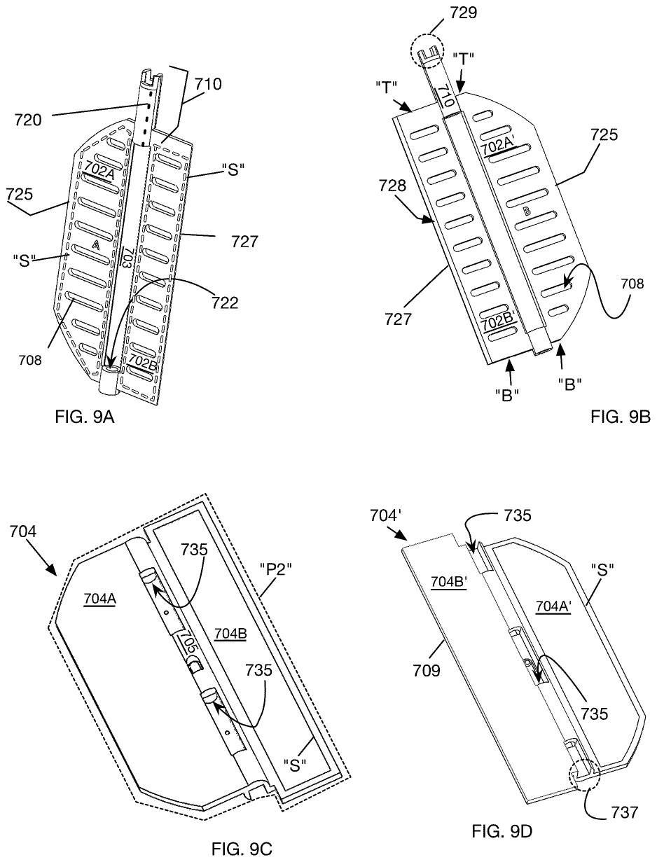

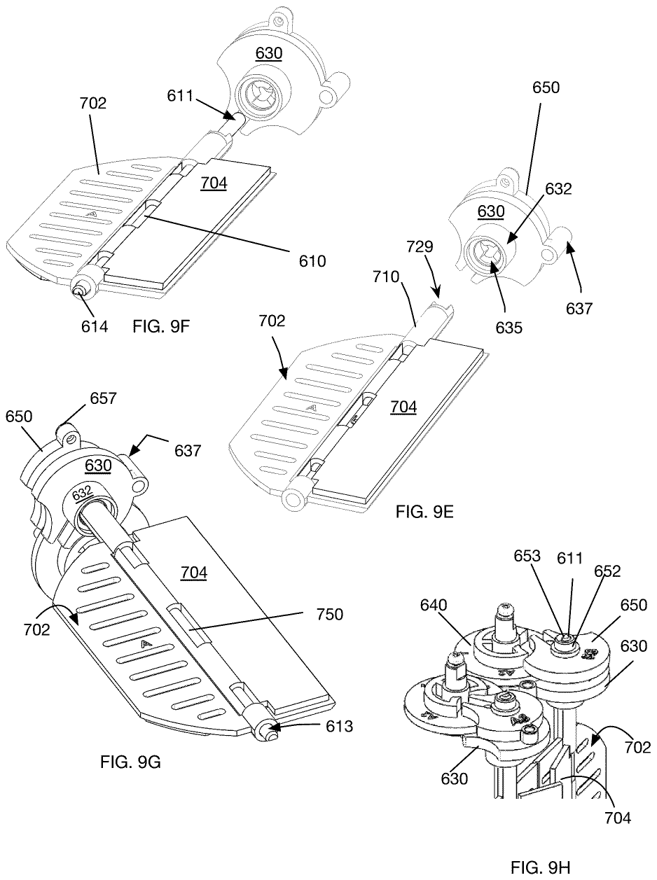

FIGS. 8-9D show is an assembly view and component views of aspects of a novel adjustable valve formed by controlling fluid flow via moving coaxial doors. Also illustrated is aspects of a drive assembly 600 which connect to and adjust positions of a plurality of movable doors 700 each on a coaxial mount. The skilled artisan and those of ordinary skill in the art will understand that the illustration of two coaxial first doors 702/702′ each with a first door coaxial mount (FDCM) 703 and two coaxial second doors 704/704′ each with a second door coaxial mount (SDCM) 705 is not a limitation and three, four or “n” doors are all within the scope of this disclosure. Each door has a front and a back side and edges. The FDCM 703 forms a passageway through the first door whereby one portion of the second door passes and the SDCM 705 of the second door fits to align with the common shaft 610. The nested arrangement forms a cooperative set of doors whereby only one face or back portion of each door is visible when the doors are parallel on the common shaft (see FIGS. 9E-9G) . For each first and second door (or additional door) the coaxial mounts are configured to cooperate with each other coaxial mount and align with a common shaft 610 having a top 611 which may be shaped or a spline, which has at least one fixture or spline 612 configured to move less than all of the coaxial doors on the common shaft and it has a bottom 613 which may be shaped or a spline to rotatable mount to the encasement or a fixture in said encasement. The outer drive assembly 675 is illustrated as being configured to operate two sets of coaxial doors. However, the skilled artisan and those of ordinary skill in the art will recognize that a single set of coaxial doors associated with a single shaft is also within the scope of the disclosure.

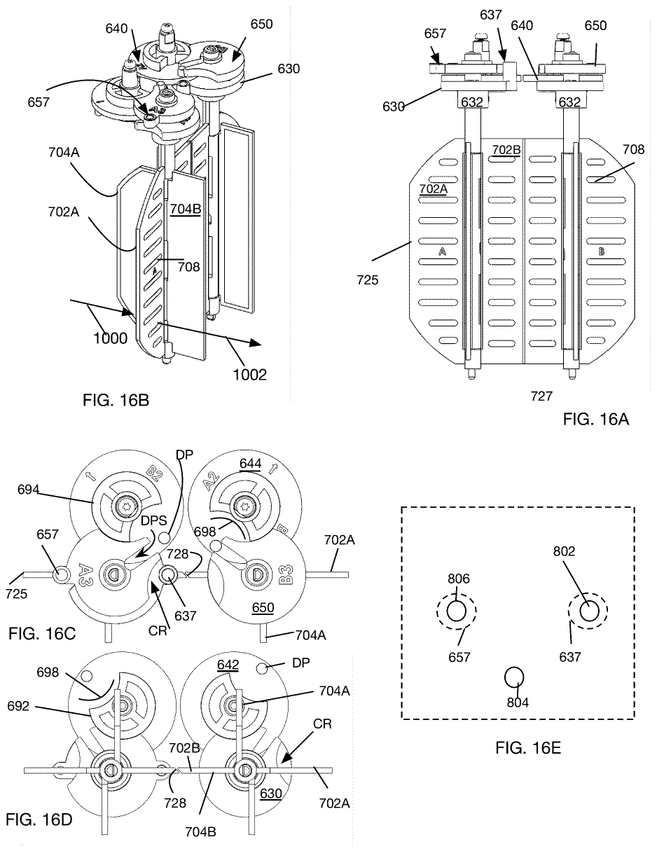

The common shaft is configured to provide alignment of the doors. For both sets of coaxial rotating doors to engage coaxial the door nest with each other whereby one door fits through a portion of the other door creating an “X” configuration whereby a portion of each door is opposite the other (see FIGS. 16A-16D). However, the first doors rotate around the shaft but are not controlled by shaft movement. Rather, the rotation of first doors is controlled by a direct mount of each first door to a lower control wheel 630. On the other hand, the upper control wheel is affixed to the shaft via splines which rotate the second doors corresponding to the upper wheel rotation.

More specifically, aspects of the first doors include each first door 702 has mounting catch 710 affixed to, or formed as part of, the door. The mounting catch 710 is configured to engage with a mounting latch 625 of a lower control wheel 630 whereby movement of said lower control wheel moves the first door 702 around the FDCM. The lower control wheel 630 is also configured whereby the common shaft 610 passes therethrough and can freely rotate within it. A dual drive wheel 640 (which also may be referred to as an actuator for one or more movable doors) is offset but stacked above the lower control wheel 630. An upper control wheel 650 is stacked above the dual drive wheel 640 and is configured to catch a spline 612 of the shaft. Each upper and lower control wheel is configured with a drive pin slot “DPS” and concave regions “CR” which cooperate for door orientation and function.

Whereby movement of the upper control wheel, causes rotational movement of the shaft 610 and at least partially moves a second door 704. The illustration of two wheel and the description of the drive wheel 640 as a “dual drive wheel” is not intended to be a limitation and those of ordinary skill in the art and the skilled artisan will understand that more than two sets of doors being driven by a drive wheel are within the scope of this disclosure.

Part of the drive assembly includes a geared wheel arrangement 680 configured to move by a force generated by a control motor or device 685 such as a motor, or other rotational input that turns said geared wheels. A main drive gear 686 connects to a pair of valve door gears 686 and 687. The valve door gears are connected and move synchronically. Valve drive gears are driven by the main drive gear. A controller 682 is configured to start/stop the control motor or device 685.

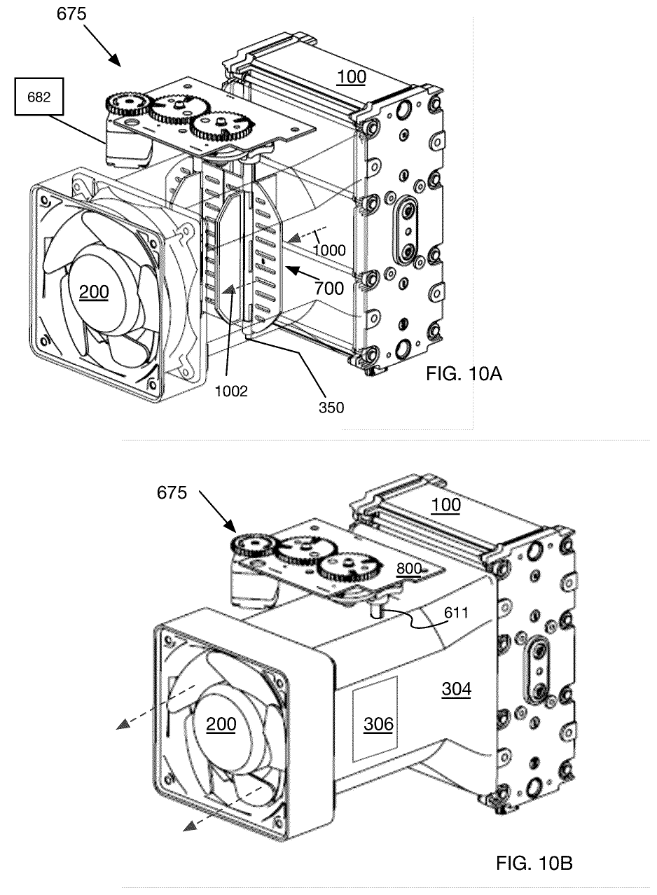

The mounting catch 710 on each first door is configured with two aligned guides 720/722 therethrough to contain the rotatable common shaft without interfering with its rotation. Each of the first doors has one or more apertures 708 therethrough which allows air passage if unsealed. On each side of the mounting catch 710 are first door panels (702A/702B and 702A′/702B′) there is an outside edge 725 shaped to match the conduit or housing (See FIG. 10A) the system controlling fluid flow is mounted within, and inside edge 727 shaped to fit tightly against the inside edge of the second first door. While airflow is discussed in this disclosure, it will be understood by those of ordinary skill in the art and the skilled artisan that air or gaseous fluid is not a limitation and all fluids may be controlled via this system and method disclosed with addition of appropriate seals (hermetic or otherwise) known in the art and the system and method herein can limit, reduce or stop flow of gaseous and aqueous fluids including but not limited to air.

Those of ordinary skill in the art or the skilled artisan will also recognize in a single first door configuration said inside edge will function as be a second outside edge and fit against the conduit or housing. On at least one of the first door's 702 inside edge a shaped region 728 may be added to overlap a portion of the other first door 702′. At the top portion of the mounting catch 710 a head 729 may be added configured to mate with a head interface on the lower control wheel. Each first door has a top edge “T” and a bottom edge “B”.

The second doors 704/704′ in this implementation are illustrated without apertures. The solid surface of the second doors is not intended to be limitation and in some instances second doors may have passages therethrough. In assembly, and during operation the SDCM 705 of each second door is fixed in alignment with a FDCM 703 of a first door. In each second door SDCM 705 is formed a shaped shaft passage 735 which has noncircular cross section 737 configured to fit at the least one fixture or spline 612 on the shaft, whereby the rotational movement of the shaft translates to movement of the second door. On each side of the second door coaxial mount (SDCM) 705 are second door panels (704A/704B and 704A′/704B′) each second door has a perimeter “P2” configured to fit within the perimeter of each first door “P1”.

Each second door 704/704′ is configured without any openings or passages and functions as a barricade or seal to reduce and or stop the flow of fluid through apertures 708 in each first door 702/702′ and may be referred to as a sealing door. Optionally a gasket, bushing, co-molded softer region or the like “S” is added to or formed a part of at least one of the first and second door.

FIGS. 9E-9H illustrates assembly of the door components of the dual rotating doors shown in FIG. 8 configured to attach to a drive system. The common shaft 610 has a top 611 which passes through the lower control wheel 630 and the dual drive wheel (DDW) 640 and is fixed into the upper control wheel 650 into a first receivor 652 with a catch 653. In operation the shaft is rotated via the action of the upper control wheel 650 whereby the attached second door(s) move accordingly. A second door sensor positional activator 657 is affixed to or formed as part of the upper control wheel.

The first door has a mounting catch 710 which is configured to mate with the lower control wheel 630. The mating may be press fit, sonic weld, or by way of a latch/catch interface with a second receivor 632. FIG. 9E illustrates aspects of a latch/catch connection interface the head 729 on the first door(s) configured to mate with a head interface 635 of the lower control wheel that is configured to mate with the head 729 of the lower control wheel 630 whereby the attached first door(s) moves rotationally about the shaft 610 when the lower control wheel moves. A first door sensor positional activator 637 is affixed to, or formed as part of, the upper control wheel. In some instances, the first door sensor positional activator is a magnet, however, those of ordinary skill in the art will recognize that sensors and the activators thereto include a plethora of possible configuration depending on the design. The function and use of the sensor positional activator is to be machine readable to provide input to a controller on the position of the sensor positional activator. In the case of a magnetic sensor positional activator the magnetic field strength can be read by a sensor to calculate (via the controller which includes microprocessor and memory) to determine position of the control wheel the sensor positional activator is attached to and the door attach to said control wheel. In the case of multiple doors which have connected gears the door positions are synchronized and only set of upper and lower control wheel provide positional data on multiple sets of coaxial rotating doors.

FIGS. 10A and 10B illustrate the use case of the valving/fluid control method and system disclosed herein in an encasement (previously referred to as a fan duct) 304 with a bypass valve or pathway 306 with the fuel cell stack 100 in fluid communication with a fan 200. A volume of fluid is pulled towards the fan along arrow 1000, passage through the plurality of movable doors 700 (shown with partial obstruction) reduces the volume in a time frame of fluid moving along arrow 1002. Control of the fluid flow between fan and fuel cell stack within the encasement is an operational adjustable valve which controls fluid flow via at least dual sets of movable doors 700 coaxial mounts. The outer drive assembly 675 controls the valve operation and hence the fluid flow between the fuel cell stack 100 and the fan 200. A control board 800 is shown. The control board provides a controller, memory, input and output interfaces, power connection and location or positional sensors. The common shaft bottom 613 mounts to the encasement at an interface 350. The top 611 of the shaft, in some instances passes through the encasement (and may be hermetically or otherwise sealed). The top 611 is connected to the outer drive assembly 675 shown outside the encasement.

FIG. 11A-11C illustrate valve states from open/unrestricted/unobstructed to sealed or obstructed with the intermediary state of restricted. In a restricted (partially obstructed) state fluid flow between the fuel cell stack and the fan is reduced via apertures 708 formed in the first door(s).

FIG. 11A shows the valve formed of dual rotating coaxial first and second doors in sealed or obstructed position within the encasement 304. The first doors and the second doors are oriented perpendicular to the encasement. Whereby fluid flow is obstructed.

FIG. 11B shows the valve formed of dual rotating coaxial first and second doors in a restricted or partially obstructed position. In this instance the second doors 704 (visible in the figure as 704B and 704B′) parallel to the encasement. The first doors 702 (visible in the figure as 702A, 702B, 702A′ and 702B′) are oriented perpendicular to the encasement whereby fluid flow is restricted to the apertures 708.

FIG. 11C shows the valve formed from the dual rotating coaxial doors in an unobstructed position. In this instance the second doors 704 (visible in the figure as 704B and 704A′) and the first doors 702 (visible in the figure as 702A and 702B′) are oriented are parallel to the encasement whereby the fluid flow is unrestricted (but for the thickness of the doors edges 727 and 709).

FIGS. 12 and 13 illustrate a dual drive wheel 640 has a first face 642 and a second face 644. It is configured to impart rotational movement to each first and second door via the lower control wheel 630 and the upper control wheel 650. A lower guide 692 cooperates with the lower control wheel during first door 702 movement. An upper guide 694 cooperates with the upper control wheel during second door 704 movement. Each guide has an indentation 698 for passage of the slot arms “SA” on each drive wheel On each dual drive wheel face is a drive pin “DP” which reversibly mates with the drive pin slot “DPS” in each of the first and second drive wheels. Accordingly, door movement of plus or minus 90 degrees is enabled with this system for each door. A valve door gear 687 is shown engaged with the main gear 686. In FIG. 13 The dual drive wheel 640 is shown in a partial drive system view engaged with an upper control wheel 650. On the dual drive wheel are the upper and lower guides. Each guide has an indentation 698 configured to accept passage of the slot arms “SA” during actuation of the control wheel via the drive pin. On each side of the slot arms “SA” are formed concave regions “CR” configured to fit against a guide (692/694). During a door moving cycle a drive pin “DP” can move in and out of the drive pin slot “DPS” and the slot arms move in and out of the indentation 698 thereby smoothly actuating a door (not shown here) driven by the upper control wheel 650.

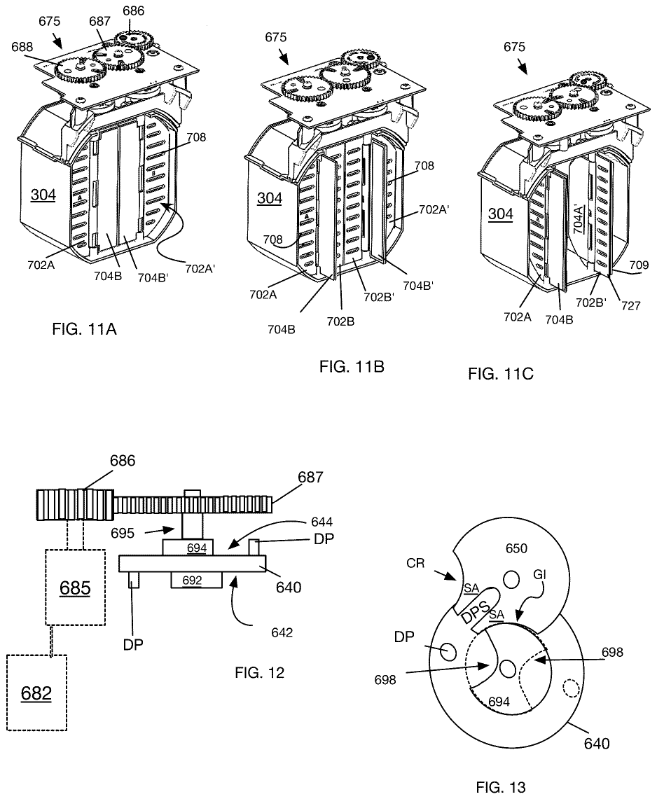

FIGS. 14A-14I illustrate a simplified view of the dual drive wheel 640 driving only the operation of the upper drive wheel 650 and an indicator “I” to illustrate the movement of an attached wall or door structure (as previously noted which may also be viewed as part of a valve which controls a fluid flow) during operation. In practice, the drive pin “DP” has many degrees of freedom whereby although the upper or lower drive wheel is rotated the drive pin “DP” said wheel only engages the drive slot “DS” for about 80 rotational degrees in this example. Should the dual drive wheel continue to rotate after the 80 degree range the drive pin does not engage the drive wheel (see FIGS. 14A, 14E, 14F and 14I) and the attached indicator “I” remains in a known position and at the same time the freedom of movement of the dual drive wheel reduces and/or eliminates overstressing the drive system as has been observed in the prior system..

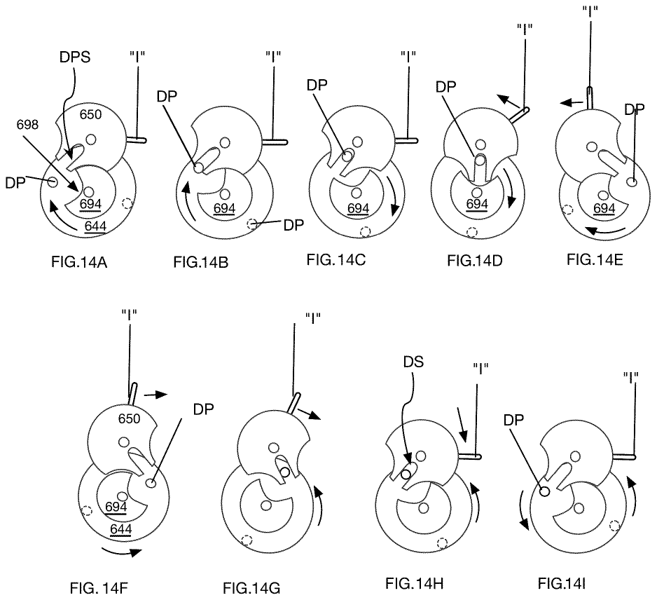

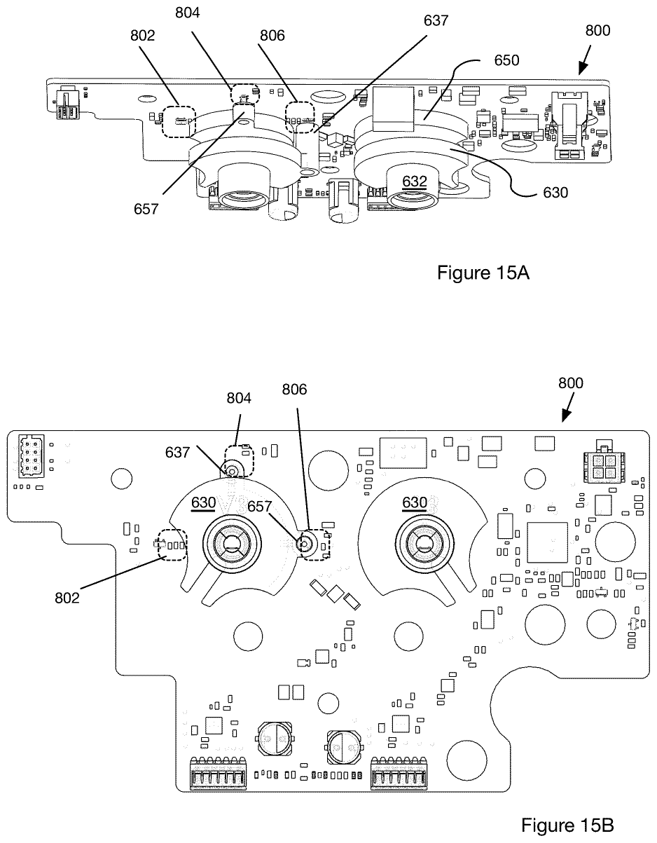

FIGS. 15A-15B shows aspects of the control board 800, with location sensors 802, 804 and 806 in predetermined orientations to measure the location of sensor positional activators (637/657). The control boar memory, inputs and outputs all of which are known in the art.

FIGS. 16A-16D show aspects of the first and second doors (and portions of the drive system) in a partially obstructed configuration as described in reference to FIG. 11B above. FIG. 16E shows relative position of sensors and sensor positional activators. The first door sensor positional activator 637 and the second door sensor positional activator 657 are configured as part of each of the upper and lower control wheels and thereby rotate along with said control wheels.

FIG. 16A is a perspective view, FIG. 16B is view of the side of the dual rotating coaxial doors corresponding to the outflow of fluid FIG. 11B). Because the first doors 702 are perpendicular to the fluid flow they are partially interfering with or obstructing the fluid flow 1000, over a given time, a reduced volume of fluid 1002 passes through the apertures 708 compared with the total volume of fluid flow1000 behind the first doors 702. The second doors 704 are in a position which is parallel to the fluid flow and therefore do not interfere with the fluid flow.

FIG. 16C illustrates a top view of FIG. 16A and FIG. 16D illustrates a bottom view of 16A. The door pins “DP” are outside of the door pin slots “DPS” and therefore the dual drive wheel may rotate beyond the aforementioned 80 degrees of movement without overstressing the drive assembly while the first and second doors remain in the selected configuration. Inside edge a shaped regions 728 on each first door are configured to fit tightly together and thereby overlap and further limit fluid flow.

The operation of the doors and the selection of the configuration is controlled via a controller configured to start/stop the control motor or device 685 based at least on the measurement of the location of at least one sensor positional activator via the location sensors (802, 804 and 806). During operation the upper and lower control wheels are driven by the dual drive wheel. The placement of the drive pins and drive pin slots are configured to actuate each of the first and second doors to either perpendicular to the fluid flow 1000 or parallel to the fluid flow.

FIG. 16E lustrates the sensor positional activators (637/657) relative to the first location sensor 802, second location sensor 804 and third location sensor 806. The sensor positional activator is shown in a dotted circle to represent the magnetic field around same. In this instance the first location sensor 802 is within the field of the first door sensor positional activator 637 and the second location sensor 804 is not within any field of either sensor positional activators. Finally, the third location sensor 806 is within the field of the second door positional activator 657, this can be represented as location sensors are in a 1-0-1 configuration with the first and third location sensors active and the second location sensor 802 in active.

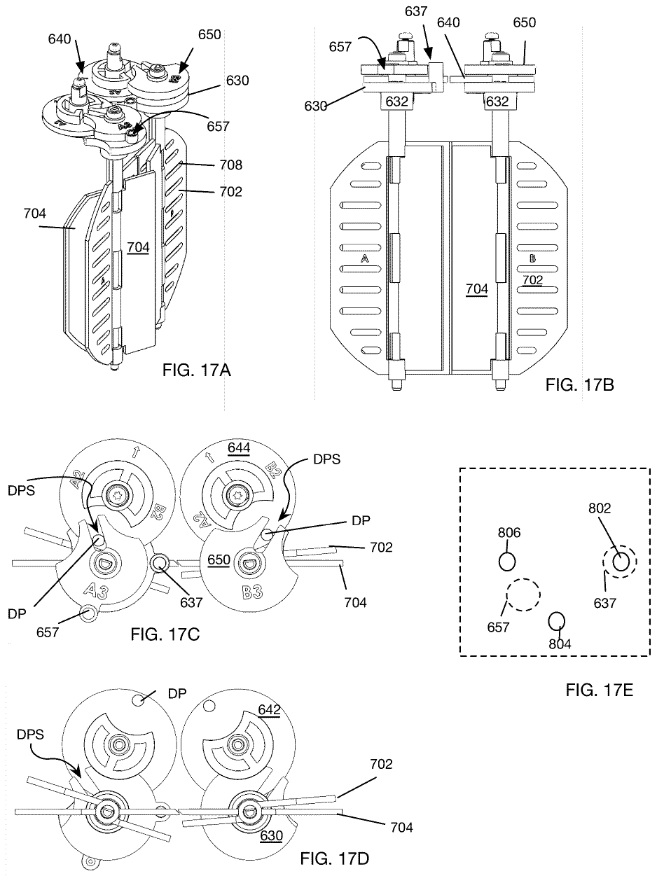

FIGS. 17A-17D show aspects of the first and second doors (and portions of the drive system) transitioning from a partially obstructed configuration as described in reference to FIGS. 16A to 16D to a sealed or obstructed position. FIG. 17E shows relative position of sensors and sensor positional activators. The first door sensor positional activator 637 and the second door sensor positional activator 657 are configured as part of each of the upper and lower control wheels and thereby rotate along with said control wheels.

FIG. 17A is a perspective view, FIG. 17B is view of the side of the dual rotating coaxial doors corresponding to the outflow of fluid (FIG. 11B). The first doors 702 remain aligned, perpendicular to fluid flow and partially obstructing the fluid flow. The second doors 704 are no longer parallel to the fluid flow and have rotated to partially block fluid flow.

FIG. 17C illustrates a top view of FIG. 17A and FIG. 17D illustrates a bottom view of 17A. The door pins “DP” associated with the dual drive wheel 640 second face 644 are within the door pin slots “DPS” and thereby are inside of the door pin slots “DPS” and therefore imparting rotation to the second doors 704 and the second door sensor positional activator 657. The door pins “DP” associated with the dual drive wheel 640 first face 642 are outside of the door pin slots “DPS” and not imparting rotation to the first doors 702 and the first door sensor positional activator 657 remains unmoved. Although the placement of the drive pins and drive pin slots are configured to actuate each of the first and second doors to either perpendicular to the fluid flow 1000 or parallel to the fluid flow FIGS. 17A-17D are examples of a transitional position whereby a full cycle of movement has not been completed therefore at least one of the first and second doors is not parallel or perpendicular to the fluid flow. Those of ordinary skill in the art will recognize the illustrations of a transitional positions of at least one of the first and second doors are not intended as limitation but rather to at least show aspects of location sensors and sensor positional activators.

FIG. 17E illustrates the sensor positional activators (637/657) relative to the first location sensor 802, second location sensor 804 and third location sensor 806. The sensor positional activator is shown in a dotted circle to represent the magnetic field around same. In this instance the first location sensor 802 is within the field of the first door sensor positional activator 637 and the second location sensor 804 and third location sensor 806 are not within any field of either sensor positional activators, this can be represented as location sensors are in a 1-0-0 configuration with the first location sensors 802 active and the second and third location sensor inactive.

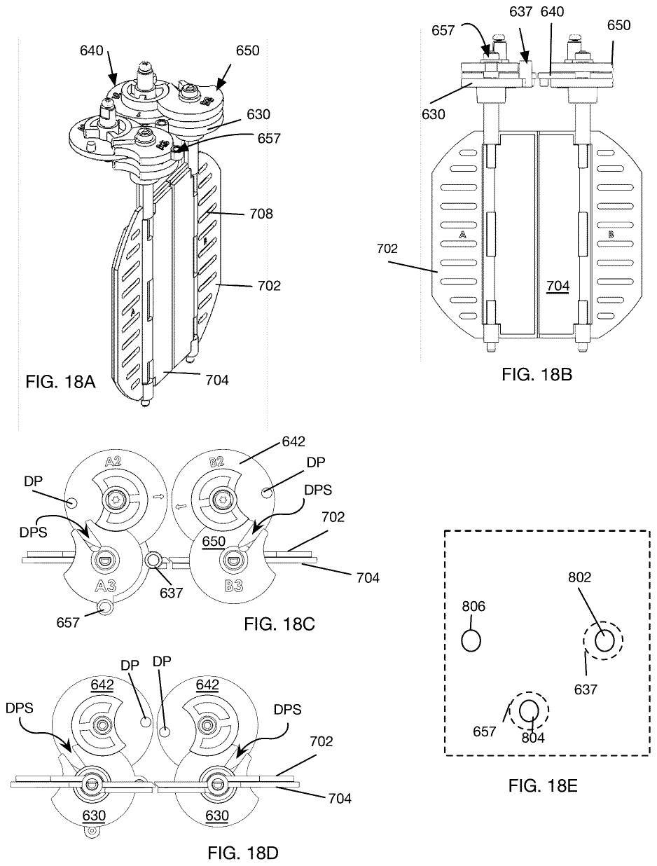

FIGS. 18A-18D show aspects of the first and second doors (and portions of the drive system) in the sealed or obstructed position from a partially obstructed configuration as described in reference to FIGS. 17A to 17D to a sealed or obstructed position. FIG. 17E shows relative position of sensors and sensor positional activators. The first door sensor positional activator 637 and the second door sensor positional activator 657 are configured as part of each of the upper and lower control wheels and thereby rotate along with said control wheels.

FIG. 18A is a perspective view, FIG. 18B is view of the side of the dual rotating coaxial doors corresponding to the outflow of fluid. The first doors 702 remain aligned, perpendicular to fluid flow. The second doors 704 have been repositioned to be parallel to the first doors. The second doors having no apertures or other fluid pathways therethrough substantially obstruct or block any fluid flow through the first door apertures. Without departing from the spirit and scope of the disclosure additional seals which are known in the art may be added around the periphery of the doors to further seal against fluid flow, in some instance the sealing may be hermetic.

FIG. 18C illustrates a top view of FIG. 18A and FIG. 18D illustrates a bottom view of 18A. In this sealed configuration the door pins “DP” associated with the dual drive wheel 640 second face 644 are remote from the door pin slots “DPS” and thereby are outside of the door pin slots “DPS” and therefore do not impart rotation to the second doors 704 and the second door sensor positional activator 657. The door pins “DP” associated with the dual drive wheel 640 first face 642 are outside of the door pin slots “DPS” and do not impart rotation to the first doors 702 and the first door sensor positional activator 657 remains unmoved. The placement of the drive pins and drive pin slots are configured to actuate each of the first and second doors to either perpendicular to the fluid flow 1000 or parallel to the fluid flow when the movement cycle is complete.

FIG. 18E illustrates the sensor positional activators (637/657) relative to the first location sensor 802, second location sensor 804 and third location sensor 806. The sensor positional activator is shown in a dotted circle to represent the magnetic field around same. In this instance the first location sensor 802 is within the field of the first door sensor positional activator 637 and the second location sensor 804 is withing the field of the second door sensor positional activator 657, the third location sensor 806 is not within any field of either sensor positional activator this can be represented as location sensors are in a 1-1-0 configuration with the first and second location sensors 802/804 active and the third location sensor 806 inactive.

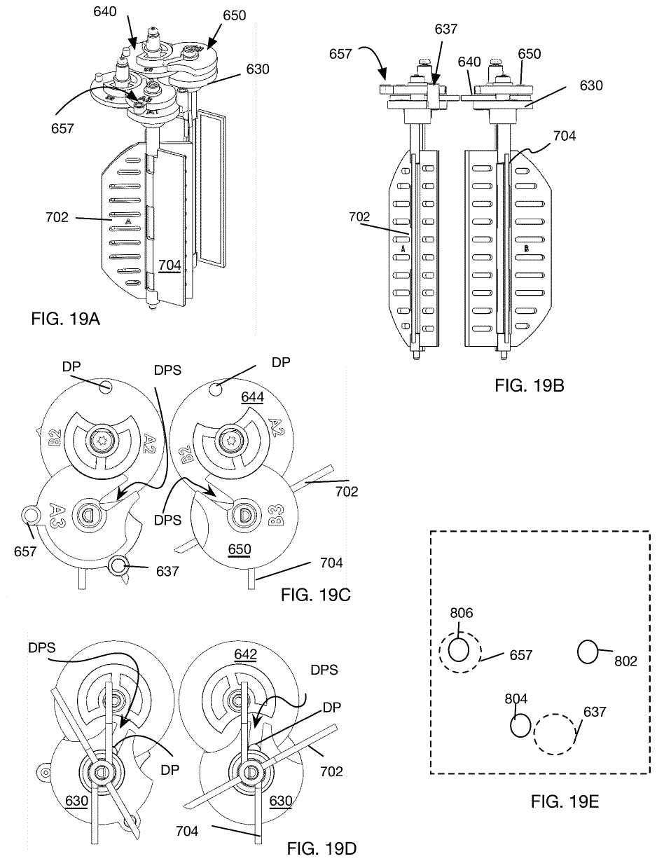

FIG. 19A is a perspective view, FIG. 19B is view of the side of the dual rotating coaxial doors corresponding to the outflow of fluid. The first doors 702 are in transition to the unobstructed position (parallel to fluid flow). The second doors 704 are transitioned to parallel to fluid flow within an encasement.

FIG. 19C illustrates a top view of FIG. 19A and FIG. 19D illustrates a bottom view of 19A. In this transitional configuration the door pins “DP” associated with the dual drive wheel 640 second face 644 are remote from the door pin slots “DPS” and thereby are outside of the door pin slots “DPS” and therefore do not impart rotation to the second doors 704 and the second door sensor positional activator 657. The door pins “DP” associated with the dual drive wheel 640 first face 642 are firmly inside the door pin slots “DPS” and do impart rotation to the first doors 702 and the first door sensor positional activator 657.

FIG. 19E illustrates the sensor positional activators (637/657) relative to the first location sensor 802, second location sensor 804 and third location sensor 806. The sensor positional activator is shown in a dotted circle to represent the magnetic field around same. In this instance the first location sensor 802 and the second location sensor 804 are outside the field of either the door sensor positional activator the third location sensor 806 is within the field of the second door positional activator thereby indicating the door position. This transitional position can be represented as location sensors are in a 0-0-1 configuration with the first and second location sensors inactive and the third location sensor 806 active.

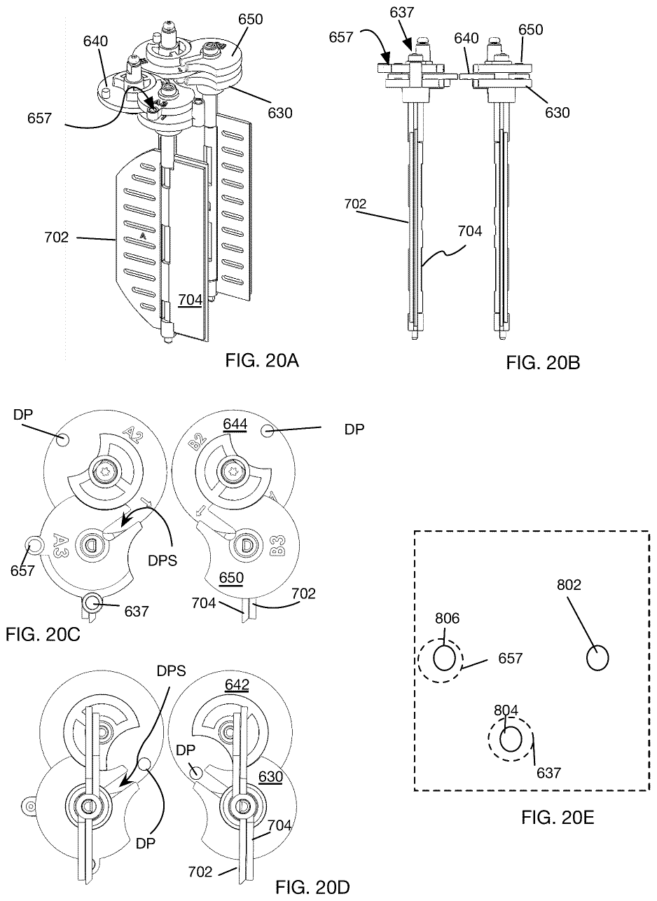

FIGS. 20A-20E represent the sequential movement from the transitional state illustrated in FIGS. 19A-19E to un unobstructed state. The sequence from transitional to unobstructed included the door pins “DP” rotating its associated upper or lower control wheel until such drive pins “DP” exited the drive pin slots “DPS” thereby leaving the first and second doors in a preselected position.

The location sensors (802/804 and 806) which are in signal communication with the controller provide input regarding the first and second door positions and said controller starts/stops the control motor or device 685 based on that input.

FIG. 20A is a perspective view, FIG. 20B is view of the side of the dual rotating coaxial doors corresponding to the outflow of fluid in an unobstructed state. The second doors 704 are aligned parallel to fluid flow. The first doors 702 have been repositioned from transitional placement (see FIGS. 19A-19E) to parallel to the second doors.

FIG. 20C illustrates a top view of FIG. 20A and FIG. 20D illustrates a bottom view of 20A. In this unobstructed configuration the door pins “DP” associated with the dual drive wheel 640 second face 644 are remote from the door pin slots “DPS” and thereby are outside of the door pin slots “DPS” and therefore do not impart rotation to the second doors 704 and the second door sensor positional activator 657. The door pins “DP” associated with the dual drive wheel 640 first face 642 are outside of the door pin slots “DPS” and do not impart rotation to the first doors 702 and the first door sensor positional activator 657 remains unmoved.

FIG. 20E illustrates the sensor positional activators (637/657) relative to the first location sensor 802, second location sensor 804 and third location sensor 806. The sensor positional activator is shown in a dotted circle to represent the magnetic field around same. In this instance the first location sensor 802 is outside the field of either sensor positional activator. The first door sensor positional activator 637 field is within the sensitivity of the second location sensor 804 and the second door sensor positional activator 657 field is within the sensitivity of the third location sensor 806 this can be represented as location sensors are in a 0-1-1 configuration with the second and third location sensors 804/806 active and the first location sensor 806 inactive.

The systems described throughout this disclosure can be utilized in a variety of applications for providing power generated by fuel cells. In some aspects, the systems disclosed throughout this application can be used in machine handling equipment (MHE), such as a forklift. In some aspects, the systems can be used in an unmanned aerial vehicle (UAV), such as a fixed or multi-rotor drones. In some aspects, the systems disclosed herein can be used in automotive applications, such as in cars. It will be appreciated that the systems can be used in a variety of other applications, and the certain functional and physical parameters, such as component sizes and quantities, may be varied for specific applications and may be dictated by requirements for specific uses. Additional advantages to those described above include being able to fit the systems and related components (such as fuel cannister cylinders) into smaller spaces and to arrange systems and related components.

The components disclosed herein may utilized known materials that are used in the industry.

Throughout this specification, words are to be afforded their normal meaning as would be understood by those skilled in the relevant art. However, so as to avoid misunderstanding, the meanings of certain terms will be specifically defined or clarified.

While the disclosure has been described in connection with the various embodiments of the various figures, it will be appreciated by those skilled in the art that changes could be made to the embodiments described above without departing from the broad inventive concept thereof. It is understood, therefore, that this disclosure is not limited to the particular embodiments disclosed, and it is intended to cover modifications within the spirit and scope of the present disclosure as defined by the claims.

Features of the disclosure that are described above in the context of separate embodiments may be provided in combination in a single embodiment. Conversely, various features of the disclosure that are described in the context of a single embodiment may also be provided separately or in any sub-combination. Finally, while an embodiment may be described as part of a series of steps or part of a more general structure, each said step may also be considered an independent embodiment in itself, combinable with others.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed:

1. A system to adjust the airflow to a fuel cell stack within an enclosure comprising:
a tubular encasement (304) forming a fluid pathway;
a fuel cell stack (100) at one end of said encasement;
a fan (200) at the other end of the encasement;
a common shaft within the encasement;
a drive assembly (600) connect two coaxial first doors each with one or more of apertures and a first door coaxial mount (FDCM) and two coaxial second doors each with a second door coaxial mount (SDCM);
wherein the common shaft passes through the FDCM and the SDCM;
each first door is also connected to a lower control wheel;
each second door is movable connect to a spline on said common shaft;
the common shaft is connected at one end to the encasement and the other end to an upper control wheel;
a dual drive wheel is configured to independently actuate each of the upper and lower control wheels; and,
wherein each actuation places each door in either perpendicular or parallel to a fluid flow.

2. The system to adjust the airflow to a fuel cell stack within an enclosure of claim 1 wherein the second door is configured to block said one or more apertures when positioned perpendicular to said fluid flow.

3. The system to adjust the airflow to a fuel cell stack within an enclosure of claim 1 wherein the drive assembly further comprises:
a control motor in signal communication with a controller;
two dual drive wheel each movably attached to a drive gear;
said drive gears are configured to rotate synchronously; and,
each dual drive wheel is configured to rotate said upper control wheel and said lower control wheel into pre-selected positions.

4. The system to adjust the airflow to a fuel cell stack within an enclosure of claim 3 further comprising:
a drive pin slot in each upper control wheel and each lower control wheel;
each dual drive wheel is configured with a pin on its first surface and its second surface; and, each pin is configured to move in and out of a drive pin slot in the upper control wheel or the lower control wheel.

5. The system to adjust the airflow to a fuel cell stack within an enclosure of claim 4 wherein each first door or second door rotates when a pin in a drive pin slot is repositioned via the dual drive wheel.

6. The system to adjust the airflow to a fuel cell stack within an enclosure of claim 5 wherein each drive pin engages a drive pin slot through less than 360 degrees of rotation of the dual drive wheel.

7. The system to adjust the airflow to a fuel cell stack within an enclosure of claim 5 wherein:
each drive pin disengages a drive pin slot through less than 360 degrees of rotation of the dual drive wheel; and,
when a drive pin is disengaged from a drive pin slot the dual drive wheel moves freely thus reducing overstressing of the drive assembly.

8. A method to control fluid flow in an enclosure, the method comprising:
an enclosure configured with a fluid pathway;
mounting a first and a second coaxial rotating doors to a common shaft in said enclosure within the fluid pathway;
wherein one of the coaxial rotating doors is configured with a plurality of apertures therethrough;
one of the coaxial doors is solid;
one end the common shaft is connected to an upper control wheel whereby when said control wheel rotates it moves one of the first or second coaxial rotating doors;
the other coaxial rotating door is movable affixed the lower control wheel which the common shaft passes through but does not rotate;
a rotating dual drive wheel configured to independently actuate both the upper and lower control wheels whereby said doors are moved into positions which place one or more of them either perpendicular to a fluid flow or parallel to the fluid flow.

9. The method to control fluid flow in an enclosure of claim 8 wherein the second door is configured to block the fluid flow through said plurality of apertures when positioned perpendicular to the fluid flow.

10. The method to control fluid flow in an enclosure of claim 8, the method further comprising:
the drive assembly includes a control motor in signal communication with a controller;
drive gears are configured to move synchronously;
wherein said synchronous gears are each attached to and rotate a dual drive wheel; and, each dual drive wheel is configured to rotate an upper control wheel and a lower control wheel into pre-selected positions.

11. The method to control fluid flow in an enclosure of claim 10, the method further comprising:
a drive pin slot in each upper control wheel and each lower control wheel;
each dual drive wheel is configured with a pin on its first surface and its second surface; and, each pin is configured to move in and out of a drive pin slot in the upper control wheel or the lower control wheel.

12. The method to control fluid flow in an enclosure of claim 11, wherein each first door or second door rotates when a pin in a drive pin slot is repositioned via the dual drive wheel.

13. The method to control fluid flow in an enclosure of claim 12, wherein each drive pin engages a drive pin slot during predetermined degrees of rotation which are less than 360 degrees of rotation of the dual drive wheel.

14. The method to control fluid flow in an enclosure of claim 12, wherein:
each drive pin disengages a drive pin slot during predetermined degrees of rotation less than 360 degrees of rotation of the dual drive wheel; and,
when a drive pin is disengaged from a drive pin slot the dual drive wheel moves freely thus reducing overstressing of the drive assembly.
